(19) United States
(12) Patent Application Publication
(10) Pub. No.: US 2011/0196680 A1
(43) Pub. Date: Aug. 11, 2011

(54) SPEECH SYNTHESIS SYSTEM

(75) Inventor: Masanori Kato, Tokyo (JP)

(73) Assignee: NEC CORPORATION, Tokyo (JP)

(21) Appl. No.: 13/125,507

(22) PCT Filed: Aug. 21, 2009
(86) PCT No.: PCT/JP2009/004004

§ 371 Date: Apr. 21, 2011

(30) Foreign Application Priority Data
Oct. 28, 2008 (JP) 2008-276654

(51) Int. Cl. G10L 13/00

(52) U.S. Cl. 704/268; 704/E13.001

(57) ABSTRACT

When a system (100) is used for synthesizing speech having prosody serving as a reference, the system stores speech element information representing a speech element capable of synthesizing speech having a degree of naturalness indicating a degree of similarity to speech uttered by a human higher than a predetermined reference value (speech element information storage (115)). The system accepts requested prosody information representing prosody requested by the user (requested prosody information accepting part (113)). The system generates intermediate prosody information representing intermediate prosody between the reference prosody and the requested prosody (intermediate prosody information generator (114)). The system executes a speech synthesis process to synthesize speech based on the generated intermediate prosody information and the stored speech element information (speech synthesizer (116)).

### TECHNICAL FIELD

The present invention relates to a speech synthesis system executing a speech synthesis process for synthesizing speech representing a text.

### BACKGROUND ART

A speech synthesis system is known which analyzes text information representing a text to synthesize speech represented by the text according to a rule-based synthesis method (i.e., to generate synthesized speech). FIG. 1 is a block diagram illustrating this type of speech synthesis system. Speech synthesis systems having such a configuration are disclosed, for example, in Non-Patent Documents 1 to 3 and Patent Documents 1 and 2 listed below.

The speech synthesis system shown in FIG. 1 has a language processor 901, a prosody estimator 902, an element information storage 905, an element selector 906, and a waveform generator 908.

The element information storage 905 stores speech element information representing speech elements generated for each of speech synthesis units, and attribute information for each of the speech elements. The speech element information is information to be used for generating synthesized speech (waveform of speech). The speech element information is often information that is extracted from speech uttered by a human (waveform of natural speech). For example, the speech element information may be generated based on information generated by recording speech uttered (pronounced) by a broadcast announcer or voice actor. The human (speaker) who has uttered the speech constituting the basis of the generated speech element information is referred to as the original speaker of the speech element.

The speech elements include, for example, waveform of speech divided (clipped) for each of the speech synthesis units, linear prediction analysis parameter, Cepstrum factor, and so on. Attribute information of each speech element consists of phonemic information such as phonological environment, pitch frequency, amplitude and duration, and prosody information of the speech constituting the basis of the speech element. The speech synthesis unit often used is a phoneme, CV, CVC, or VCV (V denotes a vowel and C denotes a consonant). The length of the speech element and particulars of the speech synthesis unit are described in Non-Patent Documents 1 to 3.

The language processor 901 executes various analyses such as morpheme analysis, syntax analysis, and text-to-speech analysis on the input text information, and outputs, to the prosody estimator 902 and the element selector 906, information indicating a symbol string for example of phoneme symbols representing “pronunciation”, and information indicating a category, conjugation, and accent type of each morpheme, as results of the language analysis process.

The prosody estimator 902 estimates prosody (information on phonetic height (pitch), phonetic length (time length), phonetic magnitude (power) and so on) of the synthesized speech on the basis of the results of the language analysis process output by the language processor 901, and outputs prosody information representing the estimated prosody to the element selector 906 and waveform generator 908.

The element selector 906 selects speech element information from the speech element information stored in the element information storage 905, in the following manner based on the results of the language analysis process and the estimated prosody, and outputs the selected speech element information and its attribute information to the waveform generator 908.

Specifically, the element selector 906 finds, for each of the speech synthesis units, information representing characteristics of the synthesized speech (hereafter, this information shall be referred to as the “target element environment”) on the basis of the received estimated prosody and results of the language analysis process. The target element environment includes relevant, preceding and following phonemes, stress status, distance from the accent nucleus, pitch frequency, power, unit duration, Cepstrum, and MFCC (Mel Frequency Cepstral Coefficient) for each speech synthesis unit, and Δ amount (variation per unit time) of these factors.

The element selector 906 then acquires, from the element information storage 5, a plurality of pieces of speech element information representing speech elements having phonemes corresponding to (e.g., coinciding with) specific information (mainly, the relevant phoneme) contained in the target element environment thus obtained. The acquired pieces of speech element information constitute candidates for speech element information used for synthesis of speech.

The element selector 906 calculates, for each of the acquired pieces of speech element information, a cost value serving as an index indicating a degree of appropriateness as speech element information to be used for synthesis of speech. The cost value becomes smaller as the degree of appropriateness becomes greater. This means that as the cost value of the speech element information used to synthesize speech becomes smaller, the speech synthesized with such speech element information exhibits a higher degree of naturalness that indicates a similarity of the synthesized speech to speech uttered by a human. In other words, the element selector 906 selects speech element information having the smallest calculated cost value.

The waveform generator 908 generates a waveform of speech, based on the selected speech element information and the prosody information selected by the prosody estimator 902, such that the prosody of the speech element represented by the speech element information is the prosody represented by the prosody information, and outputs a waveform of speech formed by connecting the generated waveform components of speech as synthesized speech.

The speech synthesis system described in Patent Document 3 is configured to synthesize speech such that the synthesized speech has the same prosody as that of speech uttered by a user (i.e., prosody requested by the user, or requested prosody). This speech synthesis system enables the user to obtain synthesized speech having prosody approximated to that of the speech uttered by the user.

### [Patent Documents]

[Patent Document 1] JP 2005-91551A

[Patent Document 2] JP 2006-84854A

[Patent Document 3] JP 2002-258885A

### [Non-Patent Documents]

[Non-Patent Document 1] Xuedong Huang, Alex Acero, Hsiao-Wuen Hon: “Spoken Language Processing”, Prentice Hall, pp. 689-836, 2001.

[Non-Patent Document 2] Ishikawa, “Prosodic Control for Japanese Text-to-Speech Synthesis”, Institute of Electronics, Information and Communication Engineers Technical Research Report, IEICE, 2000, vol. 100, no. 392, pp. 27-34.

[Non-Patent Document 3] Abe, “An Introduction to Speech Synthesis Units”, Institute of Electronics, Information and Communication Engineers Technical Research Report, 2000, IEICE, vol. 100, no. 392, pp. 35-42.

### SUMMARY

The speech synthesis system as described above stores speech element information representing a speech element capable of synthesizing speech having a higher degree of naturalness than a predetermined reference value when used for synthesizing speech having reference prosody.

Therefore, when the speech synthesis system synthesizes speech having prosody significantly different from the reference prosody, the chance is relatively high that the synthesized speech has a degree of naturalness lower than the reference value. On the other hand, the prosody requested by the user (the requested prosody) may be significantly different from the reference prosody. This leads to a problem in the above-described speech synthesis system, that speech is synthesized with an extremely low degree of naturalness (with an extremely low possibility that the speech is recognized as being uttered by a human)

This problem also occurs when the requested prosody is prosody input (or edited) by the user, or when the requested prosody is an artificially generated prosody.

It is therefore an object of the present invention to provide a speech synthesis system capable of solving the aforementioned problem, that is, the possibility of synthesis of speech with an extremely low degree of naturalness.

### Means for Solving the Problems

In order to achieve the object above, an aspect of the present invention provides a speech synthesis system comprising: speech element information storage means for storing speech element information representing a speech element capable of synthesizing speech having a degree of naturalness indicating a degree of similarity to speech uttered by a human higher than a predetermined reference value when the speech element is used for synthesizing speech having reference prosody which is prosody serving as a reference; requested prosody information accepting means for accepting requested prosody information representing requested prosody which is prosody requested by a user; intermediate prosody information generating means for generating intermediate prosody information representing intermediate prosody which is prosody between the reference prosody and the requested prosody; and speech synthesizing means for executing a speech synthesis process to synthesize speech based on the generated intermediate prosody information and the stored speech element information.

Another aspect of the present invention provides a speech synthesis method comprising: in the case that speech element information representing a speech element capable of synthesizing speech having a degree of naturalness indicating a degree of similarity to speech uttered by a human higher than a predetermined reference value, when the speech element is used for synthesizing speech having reference prosody which is prosody serving as a reference, is stored in a storage device, accepting requested prosody information representing requested prosody which is prosody requested by a user; generating intermediate prosody information representing intermediate prosody which is prosody between the reference prosody and the requested prosody; and executing a speech synthesis process to synthesize speech based on the generated intermediate prosody information and the stored speech element information.

Still another aspect of the invention provides a speech synthesis program comprising instructions for causing an information processing device to realize: speech element information storing process means for storing in a storage device speech element information representing a speech element capable of synthesizing speech having a degree of naturalness indicating a degree of similarity to speech uttered by a human higher than a predetermined reference value when the speech element is used for synthesizing speech having reference prosody which is prosody serving as a reference; requested prosody information accepting means for accepting requested prosody information representing requested prosody which is prosody requested by a user; intermediate prosody information generating means for generating intermediate prosody information representing intermediate prosody which is prosody between the reference prosody and the requested prosody; and speech synthesizing means for executing a speech synthesis process to synthesize speech based on the generated intermediate prosody information and the stored speech element information.

By being configured as described above, the present invention makes it possible to reflect the requested prosody in synthesized speech while preventing excessive deterioration in degree of naturalness of the synthesized speech.

### BRIEF DESCRIPTION OF THE DRAWINGS

FIG. 1 is a diagram illustrating a schematic configuration of a speech synthesis system according to a conventional technique;

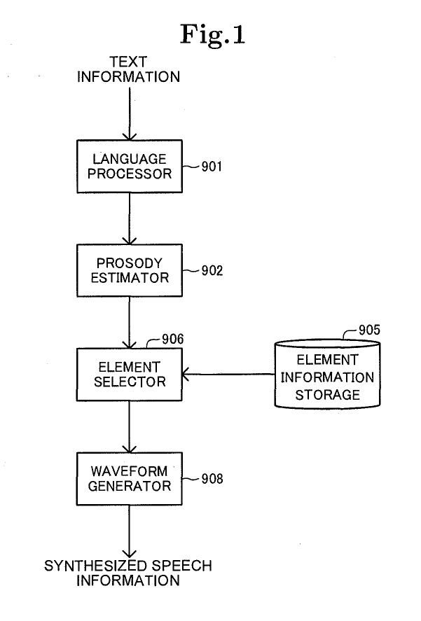

FIG. 2 is a block diagram schematically illustrating functions of a speech synthesis system according to a first embodiment of the present invention;

FIG. 3 is a flowchart illustrating a speech synthesis program to be executed on the CPU of the speech synthesis system shown in FIG. 2;

FIG. 4 is a graph conceptually illustrating a relationship among reference prosody, requested prosody, and prosody candidate;

FIGS. 5A and 5B are graphs conceptually illustrating a relationship between cost and degree of similarity of prosody candidate to reference prosody;

FIG. 6 is a flowchart illustrating a speech synthesis program to be executed on the CPU of a speech synthesis system according to a second embodiment of the present invention; and

FIG. 7 is a block diagram schematically illustrating functions of a speech synthesis system according to a third embodiment of the present invention.

### BEST MODE FOR CARRYING OUT THE INVENTION

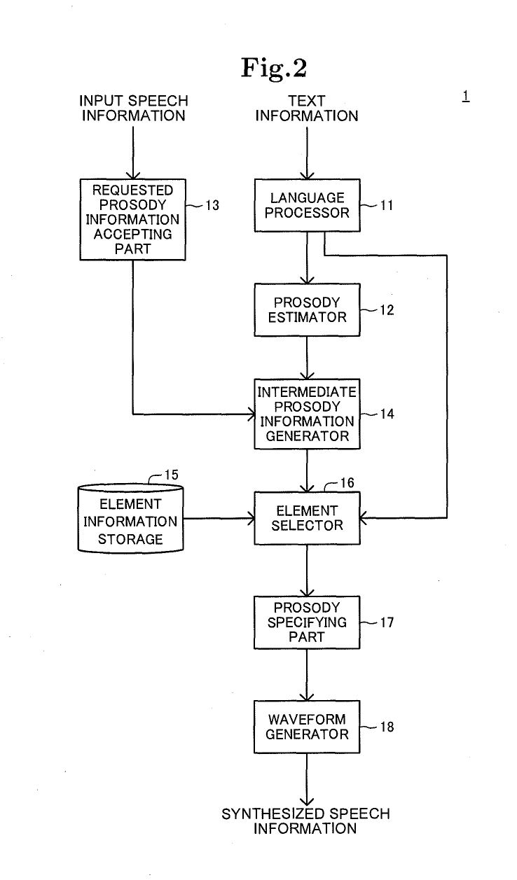

Preferred exemplary embodiments of a speech synthesis system, a speech synthesis method, and a speech synthesis program according to the present invention will be described with reference to FIGS. 2 to 7.

### First Exemplary Embodiment

(Configuration)

As shown in FIG. 2, a speech synthesis system 1 according to a first embodiment of the invention is an information processing device. The speech synthesis system 1 has a central processing unit (CPU) (not shown), a storage device (a memory and a hard disk drive (HDD)), an input device, and an output device.

The output device has a display and a speaker. The output device causes the display to display an image consisting of characters, graphics and so on based on image information output by the CPU. The output device also causes the speaker to output speech based on speech information generated by the CPU.

The input device has a mouse, a keyboard, and a microphone. The speech synthesis system 1 is designed to receive information input by a user operating the keyboard and the mouse. The speech synthesis system 1 is designed to receive, via the microphone, input speech information representing speech captured from the surrounding area of the microphone (i.e., from outside of the speech synthesis system 1).

(Functions)

Functions of the speech synthesis system 1 having the aforementioned configuration will be described below.

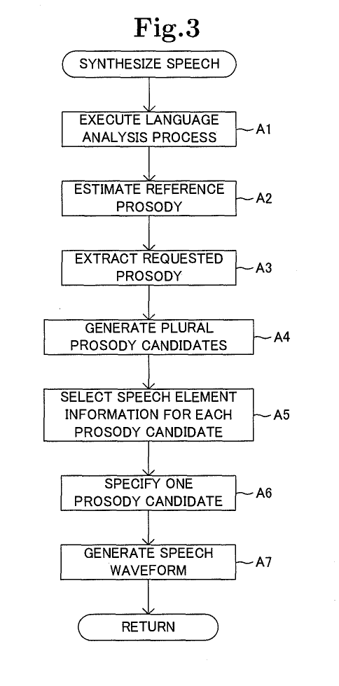

The functions of the speech synthesis system 1 include a language processor 11, a prosody estimator 12, a requested prosody information accepting part (requested prosody information accepting means) 13, an intermediate prosody information generator (intermediate prosody information generating means) 14, an element information storage (speech element information storage means, speech element information storing process, speech element information storing process means) 15, an element selector (speech element information selection means, cost calculation means, part of speech synthesizing means) 16, a prosody specifying part (part of speech synthesizing means) 17, and a waveform generator (part of speech synthesizing means) 18. These functions are realized by the CPU of the speech synthesis system 1 executing a speech synthesis program stored in the storage device and shown in FIG. 3.

The element information storage 15 preliminarily stores in the storage device speech element information representing a speech element generated for each speech synthesis unit, and attribute information of each speech element. In this example, the speech element is a waveform of speech divided (clipped) for each of the speech synthesis units. However, the speech element may be a linear prediction analysis parameter, a Cepstrum factor or the like.

The attribute information of each speech element includes phonemic information such as phonological environment, pitch frequency, amplitude and duration of the speech constituted by the speech elements, and prosody information representing prosody of the speech. In this example, the speech synthesis unit is a phoneme. However, the speech synthesis unit may be CV, CVC, VCV (V denotes a vowel and C denotes a consonant) or the like. The prosody includes a parameter representing phonetic height (pitch), a parameter representing phonetic length (duration), and a parameter representing phonetic magnitude (power).

The language processor 11 accepts text information input by the user. The language processor 11 executes a language analysis process on the text represented by the accepted text information. The language analysis process includes morpheme analyzing process, syntax analyzing process, and reading information generating process. The language processor 11 transmits, as the results of the language analysis process, information indicating a symbol string of phoneme symbols or the like representing the “reading”, and information indicating the category, conjugation, and accent type of the morpheme, to the prosody estimator 12 and the element selector 16.

The prosody estimator 12 estimates prosody serving as a reference (reference prosody) on the basis of the results of the language analysis process received from the language processor 11. The reference prosody is prosody that is set such that when speech having this reference prosody is synthesized using the speech element information stored in the element information storage 15, the synthesized speech has a higher degree of naturalness than a predetermined reference value. In other words, the speech element information stored in the element information storage 15 is such that when speech having the reference prosody is synthesized, the synthesized speech has a higher degree of naturalness than the predetermined reference value.

The term “the degree of naturalness” as used herein is a value indicating a degree of similarity to speech uttered by a human. Accordingly, it can be said that the reference prosody is prosody estimated by executing the language analysis process on the text represented by the text information.

The prosody estimator 12 transmits the reference prosody information indicating the estimated reference prosody to the intermediate prosody information generator 14.

The requested prosody information accepting part 13 accepts prosody information that is extracted from input speech information input via the microphone, as requested prosody information. The requested prosody information indicates prosody requested by the user (requested prosody). This means that the requested prosody information accepting part 13 accepts requested prosody information indicating the requested prosody, that is the prosody requested by the user.

The requested prosody information accepting part 13 uses a known method which is used for generating attribute information of speech elements as a method of extracting prosody information on the basis of the input speech information.

The requested prosody information accepting part 13 transmits the accepted requested prosody information to the intermediate prosody information generator 14.

The intermediate prosody information generator 14 generates, based on the reference prosody information received from the prosody estimator 12 and the requested prosody information received from the requested prosody information accepting part 13, a plurality of pieces of prosody candidate information each indicating a prosody candidate that is a candidate for the prosody that the speech to be synthesized is supposed to have. The prosody candidate information includes intermediate prosody information to be described below and the requested prosody information. The prosody candidate information may include the reference prosody information as well. The intermediate prosody information generator 14 transmits the generated prosody candidate information to the element selector 16.

The intermediate prosody information generator 14 generates intermediate prosody information indicating intermediate prosody that is prosody between the reference prosody and the requested prosody. The intermediate prosody information generator 14 generates a plurality of pieces of intermediate prosody information such that the similarities of the intermediate prosody indicated by the respective pieces of the intermediate prosody information to the reference prosody (or the requested prosody) are different from each other.

It should be noted that as the degree of similarity of prosody to the reference prosody becomes higher, speech synthesized with this prosody is allowed to have a higher degree of naturalness. On the other hand, as the degree of similarity of prosody to the reference prosody becomes higher, the similarity to the requested prosody becomes lower, and hence the chance that the user's request is satisfied becomes lower. Accordingly, the use of prosody between the reference prosody and the requested prosody makes it possible to increase the chance that the user's request is satisfied while avoiding excessive decrease of the degree of naturalness.

The term “the intermediate prosody” as used herein is a value obtained by internally dividing (interpolating) the reference prosody and the requested prosody. A case is assumed herein in which the prosody has K (K is an integer) elements (pitch, time length, power, etc.). In this case, the prosody can be represented by K-dimensional vector. Specifically, when reference prosody is denoted by p, requested prosody is denoted by q, and intermediate prosody is denoted by r, the reference prosody p, the requested prosody q, and the intermediate prosody r can be expressed by the following equations (1) to (3), respectively.

p=(p(1), p(2), . . . , p(K)) (1)

q=(q(1), q(2), . . . , q(K)) (2)

r=(r(1), r(2), . . . , r(K)) (3)

In this example, the component r(i) of the intermediate prosody r can be obtained by the following equation (4).

r(i)=α(i)·p(i)+(1−α(i))·q(i) (4)

However, i=1, 2, . . . , K, and α(i) is a real number satisfying 0<α(i)<1. As all of the α(i) values become closer to zero, the degree of similarity between the intermediate prosody r and the reference prosody p is increased (the intermediate prosody r becomes closer to the reference prosody p). On the other hand, as all of the α(i) values become closer to one, the degree of similarity between the intermediate prosody r and the requested prosody q is increased (the intermediate prosody r becomes closer to the requested prosody q).

The description will be made in terms of the pitch pattern as an element of the prosody.

When the pitch pattern (reference pitch pattern) as the reference prosody is denoted by f1(t) and the pitch pattern (requested pitch pattern) as the requested prosody is denoted by f2(t), the pitch pattern as the prosody candidate (candidate pitch pattern) fn(t) is derived by the following equation (5).

fn(t)=β(t)·f1(t)+(1−β(t))·f2(t) (5)

In the equation (5) above, t denotes time and β(t) is a real number satisfying 0<β(t)<1.

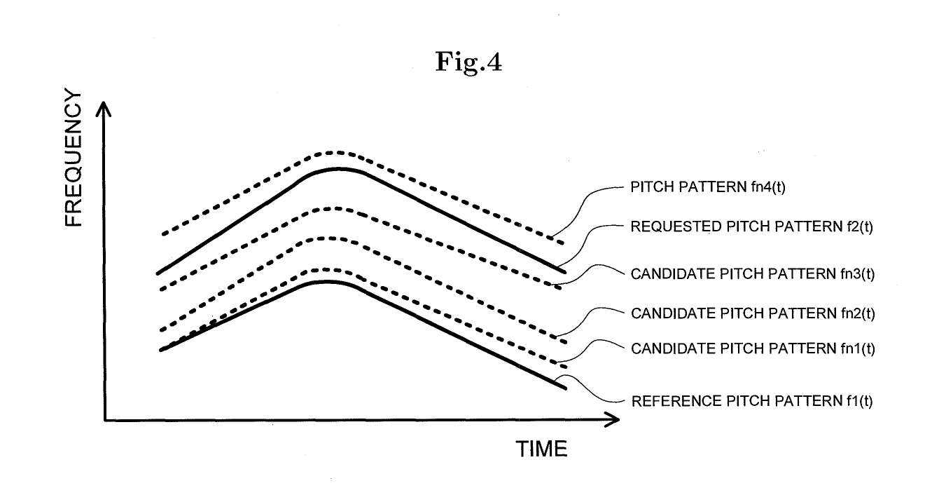

FIG. 4 is a graph illustrating examples of the reference pitch pattern f1(t), the requested pitch pattern f2(t), and the candidate pitch patterns fn1(t) to fn3(t). The solid lines indicate the reference pitch pattern f1(t) and requested pitch pattern f2(t), and the dashed lines indicate the candidate pitch patterns fn1(t) to fn3(t).

In this example, the candidate pitch pattern fn1(t) exhibits the highest degree of similarity to the reference pitch pattern f1(t). The candidate pitch pattern that exhibits the second highest similarity to the reference pitch pattern f1(t) after the candidate pitch pattern fn1(t) is the candidate pitch pattern fn2(t), followed by the candidate pitch pattern fn3(t). The pitch pattern fn4(t) is an example of prosody that is not intermediate prosody between the reference pitch pattern f1(t) and the requested pitch pattern f2(t).

In order to facilitate the selection of speech element information to be described later, the prosody candidate is generated in units used in the process for selecting the speech element information (e.g., in breath groups each bounded by periods or commas). However, the intermediate prosody need not be generated in the same units as those used in the process for selecting the speech element information. For example, prosody may also be generated as a prosody candidate such that the prosody has a degree of similarly to the reference prosody differing in units of accent phrases (phrases including a single accent).

Based on the prosody candidate information received from the intermediate prosody information generator 14, the results of the language analysis process received from the language processor 11, and the speech element information stored in the element information storage 15, the element selector 16 selects, for each of prosody candidate represented by the prosody candidate information, speech element information corresponding to the prosody candidate from the stored speech element information.

More specifically, the element selector 16 executes the following process on each of the prosody candidates.

The element selector 16 finds information representing characteristics of synthesized speech (target element environment) for each of the speech synthesis units, based on the results of the language analysis process and the prosody candidate. The target element environment includes relevant, preceding and following phonemes, stress status, distance from the accent nucleus, pitch frequency, power, unit duration, Cepstrum, and MFCC (Mel Frequency Cepstral Coefficient) for each speech synthesis unit, and Δ amount (variation per unit time) of these factors. The element selector 16 selects speech element information representing a speech element having a phoneme corresponding to (e.g., coinciding with) specific information (mainly, the relevant phoneme) included in the target element environment.

The element selector 16 then calculates a cost value based on the selected speech element information. The cost value is an index indicating a degree of appropriateness of the speech element information to be used for synthesizing speech. In other words, the cost value is a value which varies according to the degree of naturalness of the speech that is synthesized to have the prosody candidate.

More specifically, the cost value includes a parameter indicating a degree of difference between the element environment of the stored speech element information and the target element environment, and a parameter indicating a degree of difference in element environment between the speech elements mutually connected. The cost value increases as the degree of difference between the element environment of the stored speech element information and the target element environment becomes greater. The cost also increases as the degree of difference in element environment between the connected speech elements becomes greater. Consequently, it can be said that the cost value is a value that becomes greater as the degree by which the degree of naturalness is lower than the reference value becomes greater.

The cost value is calculated for example using the target element environment, pitch frequency at the element connection boundary, Cepstrum, MFCC, short-time autocorrelation, power, and Δ amount (variation per unit time) of these. Particulars of the cost value are described in JP 2006-84854A, 2005-91551A and other documents, and hence the description thereof will be omitted herein.

The element selector 16 selects, from the selected speech element information, speech element information the calculated cost value for which is minimum, as the speech element information corresponding to the prosody candidate.

In this manner, the element selector 16 selects, for each of the prosody candidates, from the stored speech element information, speech element information corresponding to the prosody candidate.

The element selector 16 then transmits to the prosody specifying part 17 the speech element information selected for each of the prosody candidates and the cost value calculated based on the selected speech element information together with prosody candidate information representing the prosody candidate.

Although the pieces of speech element information selected for the respective prosody candidates often differ from each other, they may be the same in some cases. For example, when the prosody candidates generated by the intermediate prosody information generator 14 are similar to each other, or when the element information storage 15 stores a small number of pieces of speech element information, the possibility is increased that the same speech element information is selected for several prosody candidates.

The prosody specifying part 17 specifies one of the prosody candidates on the basis of the cost values, the speech element information, and the prosody candidate information received from the element selector 16.

The degree of naturalness tends to be decreased as the prosody becomes closer to the requested prosody (i.e., as the prosody becomes further away from the reference prosody). Therefore, the prosody specifying part 17 specifies the prosody candidate such that it is as close as possible to the requested prosody to the extent that the degree of naturalness of the synthesized speech satisfies a preset tolerance level.

More specifically, the prosody specifying part 17 specifies a prosody candidate that has the highest degree of similarity to the requested prosody among the prosody candidates the calculated cost values of which are smaller than the predetermined threshold. If there is no prosody candidate the cost value of which is smaller than the threshold, the prosody specifying part 17 then specifies a prosody candidate having the highest degree of similarity to the reference prosody.

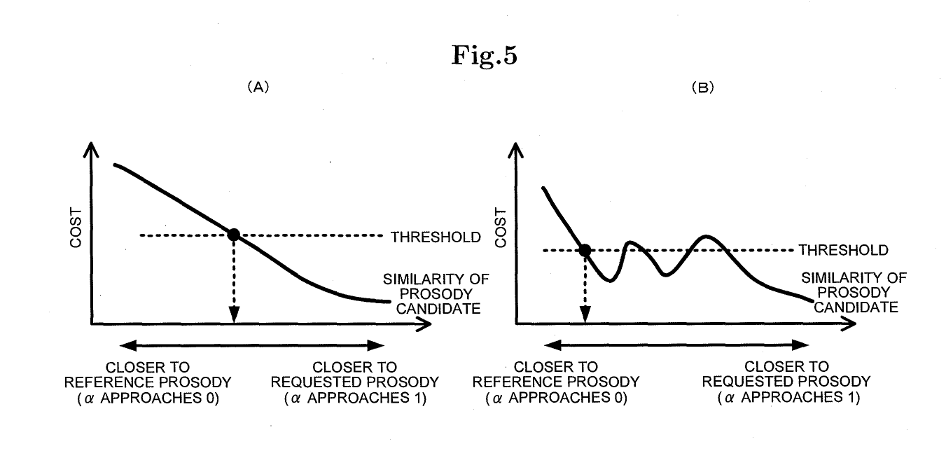

A description will be made of relationship between cost value and prosody candidate with reference to FIGS. 5A and 5B. In FIGS. 5A and 5B, the ordinate represents the cost value, and the abscissa represents the degree of similarity of the prosody candidates to the reference prosody (the degree of similarity between the prosody candidates and the reference prosody, corresponding to α in the equation (4) above).

As shown in FIG. 5A, it is often the case that as the degree of similarity of a prosody candidate to the reference prosody is increased, the cost value thereof decreases (this means that the cost value decreases monotonically). However, as shown in FIG. 5B, in some cases, the cost value does not decrease monotonically as the degree of similarity of the prosody candidate to the reference prosody is increased. When a threshold is set as shown in FIGS. 5A and 5B, a prosody candidate corresponding to the filled circle is specified.

In this example, the threshold is a preset value (constant value). The threshold may be set based on the cost value transmitted from the element selector 16. This ensures appropriate setting of the threshold. Specifically, the prosody specifying part 17 sets a threshold Th according to the following equation (6) on the basis of a maximum value Smax and a minimum value Smin of the cost values received from the element selector 16.

Th=Smax−c·(Smax−Smin) (6)

In the equation above, c denotes a real number satisfying 0<c<1. When the prosody specifying part 17 recognizes that the reference prosody is used as the prosody candidate, the cost value that is calculated for the prosody candidate may be used as the minimum cost value Smin. Likewise, when the prosody specifying part 17 recognizes that the requested prosody is used as the prosody candidate, the cost value that is calculated for the prosody candidate may be used as the maximum cost value Smax.

The prosody specifying part 17 then transmits the specified prosody candidate information and the speech element information transmitted together with this prosody candidate information to the waveform generator 18.

Based on the speech element information and the prosody candidate information received from the prosody specifying part 17, the waveform generator 18 generates a waveform of speech such that the prosody of the speech element represented by the speech element information is the prosody represented by the prosody candidate information, and outputs, as synthesized speech, a waveform of speech formed by connecting the generated waveforms of speech. This means that the waveform generator 18 executes a speech synthesis process for synthesizing speech having the prosody candidate specified by the prosody specifying part 17.

(Operation)

Operation of the abovedescribed speech synthesis system 1 will be described more specifically.

The CPU of the speech synthesis system 1 is designed to execute the speech synthesis program shown by the flowchart of FIG. 3 according to a start instruction given by the user.

More specifically, when execution of the speech synthesis program is started, the CPU stands by until text information is input by the user in step 305. Upon the text information being input by the user, the CPU accepts the input text information, and executes a language analysis process on the text represented by the accepted text information. The CPU then outputs a result of the language analysis process (step A1).

The CPU then estimates reference prosody on the basis of the output result of the language analysis process, and outputs reference prosody information representing the estimated reference prosody (step A2). Subsequently, the CPU stands by until input speech information is input by the user. Once the input speech information is input by the user, the CPU accepts the input speech information input by the user, and extracts requested prosody information based on the accepted input speech information (step A3, requested prosody information accepting step).

Subsequently, based on the output reference prosody information and the extracted requested prosody information, the CPU generates a plurality of pieces of prosody candidate information representing prosody candidates as candidates for the prosody of the speech to be synthesized (step A4, intermediate prosody information generating step).

The CPU then selects, from the speech element information stored in the storage device, corresponding speech element information for each of the prosody candidates represented by the prosody candidate information on the basis of the generated prosody candidate information, the output result of the language analysis process, and the speech element information stored in the storage device.

Specifically, the CPU selects speech element information, for each of the prosody candidates, representing a speech element having a phoneme corresponding to specific information included in the target element environment, and calculates a cost value based on the selected speech element information (cost calculation step). The CPU then selects speech element information providing the minimum cost value from the selected speech element information, as the speech element information corresponding to the prosody candidate (step A5, speech element information selecting step).

Subsequently, the CPU specifies a prosody candidate having the highest degree of similarity to the requested prosody among the prosody candidates the calculated cost values of which are smaller than a predetermined threshold (step A6). The CPU then generates a waveform of speech such that the specified prosody candidate is the prosody of the speech element represented by the speech element information selected according to the specified prosody candidate. The CPU then outputs a waveform of speech formed by connecting the generated waveforms of speech by means of the speaker, as synthesized speech (step A7, speech synthesis step).

The speech synthesis system 1 according to the first embodiment of the present invention, as described above, is designed to synthesize speech on the basis of intermediate prosody that is prosody between reference prosody and requested prosody. This makes it possible to increase the degree of naturalness of synthesized speech in comparison with when speech is synthesized to have requested prosody. In other words, the requested prosody can be reflected in the synthesized speech while avoiding excessive reduction in the degree of naturalness of the synthesized speech.

Furthermore, according to the first embodiment, the prosody candidate to be used for synthesizing speech is determined based on the cost value that is variable according to the degree of naturalness. This makes it possible to reliably prevent the excessive reduction in the degree of naturalness.

In addition, according to the first embodiment, speech can be synthesized having the most similar prosody to the requested prosody within a sufficiently wide range of degrees of naturalness. Therefore, the degree in which the requested prosody is reflected in the synthesized speech can be increased while preventing excessive reduction in the degree of naturalness of the synthesized speech. As a result, the possibility of satisfying the user's request can be increased.

In a modification example of the first embodiment, the speech synthesis system 1 may be configured to generate a plurality of pieces of intermediate prosody information in parallel. For example, when the speech synthesis system 1 has a circuit for generating intermediate prosody information, the speech synthesis system 1 may be provided with a plurality of circuit parts each for generating a single piece of intermediate prosody information. Alternatively, the CPU of the speech synthesis system 1 may be designed to execute parallel processes.

### Second Embodiment

Next, a speech synthesis system according to a second embodiment of the present invention will be described. The speech synthesis system according to the second embodiment is different from the abovedescribed speech synthesis system according to the first embodiment in that cost values are calculated for respective prosody candidates in descending order from the one having the highest degree of similarity to the requested prosody, and the first prosody candidate providing a smaller cost value calculated therefor than the threshold is used to execute a speech synthesis process. Therefore, the following description will be focused on such different features.

The element selector 16 according to the second embodiment generates (acquires) prosody candidates one by one in descending order from the one having the highest degree of similarity to the requested prosody, and calculates a cost value for each of the acquired prosody candidates.

Further, once one of the calculated cost values becomes smaller than the threshold, the prosody specifying part 17 specifies the prosody candidate for which this cost value has been calculated.

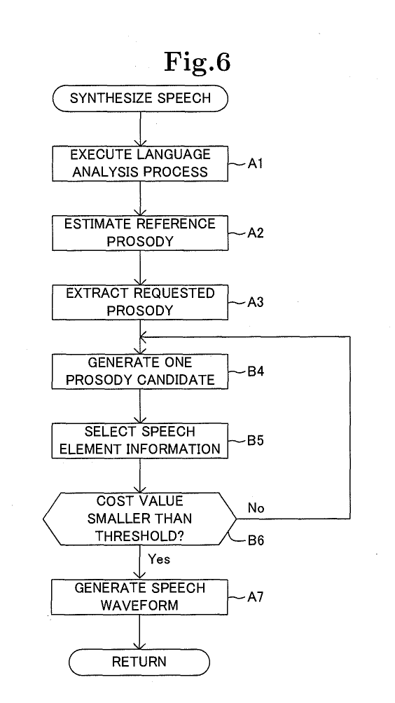

The CPU of the speech synthesis system 1 according to the second embodiment is designed to execute a speech synthesis program shown in FIG. 6 instead of the speech synthesis program shown in FIG. 3.

First, like in the first embodiment, the CPU executes processes of steps A1 to A3. Then, the CPU generates only one piece of prosody candidate information (step B4). Every time the process of step B4 is repeatedly executed, the CPU generates prosody candidate information such that the degree in which the prosody candidate represented by the generated prosody candidate information is similar to the requested prosody becomes smaller (lower).

The CPU then selects speech element information corresponding to the prosody candidate represented by the prosody candidate information from the stored speech element information, on the basis of the output prosody candidate information, the output result of the language analysis process, and speech element information stored in the storage device.

Specifically, the CPU selects speech element information representing a speech element having a phoneme corresponding to specific information included in the target element environment, and calculates a cost value based on the selected speech element information. The CPU then selects, from the selected speech element information, speech element information the calculated cost value for which is minimum, as the speech element information corresponding to the prosody candidate described above (step B5).

Subsequently, the CPU determines whether or not the cost value calculated for the selected speech element information is smaller than the threshold (step B6).

The description here will be continued on the assumption that the calculated cost value is greater than the threshold. When the calculated cost value is greater than the threshold, the CPU determines “NO” in step B6 and returns to step B4, and repeatedly executes the processes of steps B4 to B6.

When the cost value becomes smaller than the threshold after that, the CPU determines “Yes” in step B6 and proceeds to step A7. The CPU then generates a waveform of speech such that the prosody candidate is the prosody of the speech element represented by the speech element information selected according to the latest generated prosody candidate. Subsequently, the CPU outputs a waveform of speech formed by connecting the generated waveforms of speech as synthesized speech by means of the speaker (step A7).

According to the second embodiment as described above, the same advantageous effects as those of the first embodiment can be obtained. Furthermore, according to the second embodiment, useless calculation of cost values can be avoided. This makes it possible to reduce the processing load required for the speech synthesis system 1 to calculate the cost values.

### Third Embodiment

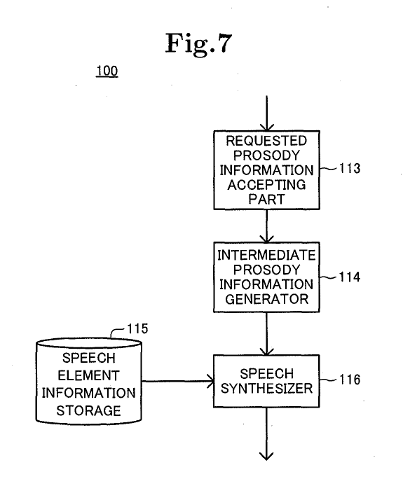

Next, a speech synthesis system according to a third embodiment of the present invention will be described with reference to FIG. 7.

Functions of the speech synthesis system 100 according to the third embodiment includes a requested prosody information accepting part 113, an intermediate prosody information generator 114, a speech element information storage 115, and a speech synthesizer 116.

When the system is used to synthesize speech having reference prosody, that is prosody serving as a reference, the speech element information storage 115 stores speech element information representing speech elements capable of synthesizing speech having a degree of naturalness, or a degree of similarity to speech uttered by a human, that is higher than a predetermined reference value.

The requested prosody information accepting part 113 accepts requested prosody information representing requested prosody, that is prosody requested by the user.

The intermediate prosody information generator 114 generates intermediate prosody information representing intermediate prosody, that is prosody between the reference prosody and the requested prosody.

The speech synthesizer 116 executes a speech synthesis process for synthesizing speech on the basis of the intermediate prosody information generated by the intermediate prosody information generator 114 and the speech element information stored in the speech element information storage 115.

This makes it possible to improve the degree of naturalness of the speech (synthesized speech) in comparison with the case in which speech is synthesized to have the requested prosody. In other words, the requested prosody can be reflected in the synthesized speech while avoiding excessive reduction in the degree of naturalness of the synthesized speech.

In this case, the speech synthesizing means described above preferably includes: speech element information selection means for selecting, for each of the prosody candidates including the intermediate prosody, speech element information corresponding to the prosody candidate from the stored speech element information; and cost calculation means for calculating, for each of the prosody candidates, a cost value that is variable according to the degree of naturalness of the speech when speech having the prosody candidate is synthesized, based on the selected speech element information. Further, the speech synthesizing means is preferably configured to specify one of the prosody candidates based on the calculated cost values, and execute the speech synthesis process to synthesize speech having the specified prosody candidate based on the speech element information selected for the specified prosody candidate.

According to this configuration, a prosody candidate to be used for synthesizing speech is determined based on the cost value that is variable according to the degree of naturalness. This makes it possible to reliably prevent the excessive reduction in the degree of naturalness.

In this case, it is preferable that the cost value is a value that increases as the degree to which the degree of naturalness becomes lower than the reference value is increased, and the speech synthesizing means is configured to specify a prosody candidate having the highest degree of similarity to the requested prosody among the prosody candidates the calculated cost values of which are smaller than a predetermined threshold.

According to this configuration, speech can be synthesized having prosody that is most similar (closest) to the requested prosody within a sufficiently wide range of degree of naturalness. Therefore, the degree to which the requested prosody is reflected in the synthesized speech can be increased while avoiding the excessive reduction in the degree of naturalness of the synthesized speech. This makes it possible to increase the possibility that the user's request is satisfied.

In this case, the speech synthesizing means is preferably configured to set the threshold on the basis of a maximum value and a minimum value of the calculated cost values.

This ensures appropriate setting of the threshold.

In this case, the cost calculation means is preferably configured to acquire prosody candidates one by one in descending order from the one having the highest degree of similarity to the requested prosody, and calculate the cost value for each of the acquired prosody candidates, and when the calculated cost value becomes smaller than the threshold, the speech synthesizing means specifies a prosody candidate for which this cost value has been calculated, and executes the speech synthesis process for synthesizing speech having the specified prosody candidate based on the speech element information selected for the specified prosody candidate.

The possibility of increase of a cost value of prosody increases as the degree of similarity of the prosody to the requested prosody is increased. Therefore, according to the configuration described above, useless calculation of cost values can be avoided. This makes it possible to reduce the processing load required for the speech synthesis system to calculate the cost values.

In this case, the reference prosody is preferably prosody estimated by executing a language analysis process on a text.

In this case, the speech synthesis system is preferably such that each of the reference prosody and the requested prosody includes at least one of a parameter representing the phonetic height, a parameter representing the phonetic length, and a parameter representing the phonetic magnitude.

A speech synthesis method according to another aspect of the invention comprises: in the case that speech element information representing a speech element capable of synthesizing speech having a degree of naturalness indicating a degree of similarity to speech uttered by a human higher than a predetermined reference value, when the speech element is used for synthesizing speech having reference prosody which is prosody serving as a reference, is stored in a storage device, accepting requested prosody information representing requested prosody which is prosody requested by a user; generating intermediate prosody information representing intermediate prosody that is prosody between the reference prosody and the requested prosody; and executing a speech synthesis process to synthesize speech based on the generated intermediate prosody information and the stored speech element information.

In this case, the speech synthesis method is preferably designed to include: selecting, for each of prosody candidates including the intermediate prosody, speech element information corresponding to the prosody candidate from the stored speech element information; calculating, for each of the prosody candidates, a cost value which varies according to the degree of naturalness of speech synthesized to have the prosody candidate, based on the selected speech element information; specifying one of the prosody candidates based on the calculated cost values, and executing the speech synthesis process to synthesize speech having the specified prosody candidate based on the speech element information selected for the specified prosody candidate.

In this case, it is preferable that: the cost value is a value that increases as the degree to which the degree of naturalness is lower than the reference value becomes higher; and the prosody candidate having the highest degree of similarity to the requested prosody is specified among the prosody candidates the calculated cost values of which are smaller than the predetermined threshold.

A speech synthesis program according to another aspect of the present invention is a program comprising instructions for causing an information processing device to realize: speech element information storing process means for storing in a storage device speech element information representing a speech element capable of synthesizing speech having a degree of naturalness indicating a degree of similarity to speech uttered by a human higher than a predetermined reference value when the speech element is used for synthesizing speech having reference prosody which is prosody serving as a reference; requested prosody information accepting means for accepting requested prosody information representing requested prosody which is prosody requested by a user; intermediate prosody information generating means for generating intermediate prosody information representing intermediate prosody which is prosody between the reference prosody and the requested prosody; and speech synthesizing means for executing a speech synthesis process to synthesize speech based on the generated intermediate prosody information and the stored speech element information.

In this case, it is preferable that the speech synthesizing means includes: speech element information selection means for selecting, for each of the prosody candidates including the intermediate prosody, speech element information corresponding to the prosody candidate from the stored speech element information; and cost calculation means for calculating, for each of the prosody candidates, a cost value varying according to the degree of naturalness of speech synthesized to have the prosody candidate, based on the selected speech element information; and the speech synthesizing means is configured to specify one of the prosody candidates based on the calculated cost values, and execute the speech synthesis process to synthesize speech having that prosody candidate, based on the speech element information selected for the specified prosody candidate.

In this case, it is preferable that: the cost value is a value becoming greater as the degree to which the degree of naturalness is lower than the reference value becomes higher; and the speech synthesizing means is configured to specify a prosody candidate having the highest degree of similarity to the requested prosody among the prosody candidates the calculated cost values of which are smaller than a predetermined threshold.

The speech synthesis method or the speech synthesis program of the invention having the configuration described above is also capable of achieving the object of the present invention since it has the same effects as those of the speech synthesis system described above.

Although the present invention has been described with reference to its exemplary embodiments, the invention is not limited to these exemplary embodiments. Configuration and particulars of the present invention may be altered variously as conceivable by those skilled in the art without departing from the scope of the claims of the present invention.

For example, although in the exemplary embodiments described above, the requested prosody information is information based on speech uttered by the user, the requested prosody information may be information based on information input by a user using an input device (keyboard, mouse, or the like). For example, information obtained by the user editing prosody information stored in the speech synthesis system 1 may be used as the requested prosody information.

Although in the exemplary embodiments described above, the program is stored in the storage device, it may be stored in a computer-readable recording medium. For example, such recording medium may be a medium with portability such as a flexible disk, an optical disk, an magneto-optical disk, and a semiconductor memory.

Further, any combination of the aforementioned exemplary embodiments and modification examples may be employed as another modification example of the exemplary embodiments.

The present invention enjoys the benefit of priority from Japanese patent application No. 2008-276654, filed Oct. 28, 2008, the disclosure of which is incorporated in this specification in its entirety.

### INDUSTRIAL APPLICABILITY

The present invention is applicable to speech synthesis systems in general executing a speech synthesis process for synthesizing speech representing a text.

### LIST OF REFERENCE NUMERALS

1 Speech synthesis system
11 Language processor
12 Prosody estimator
13 Requested prosody information accepting part
14 Intermediate prosody information generator
15 Element information storage
16 Element selector
17 Prosody specifying part
18 Waveform generator
100 Speech synthesis system
113 Requested prosody information accepting part
114 Intermediate prosody information generator
115 Speech element information storage
116 Speech synthesizer
901 Language processor
902 Prosody estimator
905 Element information storage
906 Element selector
908 Waveform generator

1. A speech synthesis system comprising:
speech element information storage unit for storing speech element information representing a speech element capable of synthesizing speech having a degree of naturalness indicating a degree of similarity to speech uttered by a human higher than a predetermined reference value when the speech element is used for synthesizing speech having reference prosody which is prosody serving as a reference;
requested prosody information accepting unit for accepting requested prosody information representing requested prosody which is prosody requested by a user;
intermediate prosody information generating unit for generating intermediate prosody information representing intermediate prosody which is prosody between the reference prosody and the requested prosody; and
speech synthesizing unit for executing a speech synthesis process to synthesize speech based on the generated intermediate prosody information and the stored speech element information.

2. The speech synthesis system according to claim 1, wherein:
the speech synthesizing unit comprises:
speech element information selection unit for selecting, for each of prosody candidates including the intermediate prosody, speech element information corresponding to the prosody candidate from the stored speech element information; and
cost calculation unit for calculating, for each of the prosody candidates, a cost value varying according to the degree of naturalness of speech synthesized to have the prosody candidate, based on the selected speech element information, and
the speech synthesizing unit is configured to specify one of the prosody candidates based on the calculated cost values, and execute the speech synthesis process to synthesize speech having the specified prosody candidate based on the speech element information selected for the specified prosody candidate.

3. The speech synthesis system according to claim 2, wherein:
the cost value is a value that increases as the degree to which the degree of naturalness is lower than the reference value becomes higher ; and
the speech synthesizing unit is configured to specify a prosody candidate having the highest degree of similarity to the requested prosody among the prosody candidates the calculated cost values of which are smaller than a predetermined threshold.

4. The speech synthesis system according to claim 3, wherein the speech synthesizing unit is configured to set the threshold on the basis of a maximum value and a minimum value of the calculated cost values.

5. The speech synthesis system according to claim 3, wherein:
the cost calculation unit is configured to acquire the prosody candidates one by one in descending order from the prosody candidate having the highest similarity to the requested prosody and calculate the cost value for the acquired prosody candidate; and
the speech synthesizing unit is configured to, when the calculated cost value becomes smaller than the threshold, specify the prosody candidate for which the cost value has been calculated, and execute the speech synthesis process to synthesize speech having the specified prosody candidate, based on the speech element information selected for the specified prosody candidate.

6. The speech synthesis system according to claim 1, wherein the reference prosody is prosody estimated by executing a language analysis process on a text.

7. The speech synthesis system according to claim 1, wherein the reference prosody and the requested prosody each include at least one of a parameter representing phonetic height, a parameter representing phonetic length, and a parameter representing phonetic magnitude

8. A speech synthesis method comprising:
in the case that speech element information representing a speech element capable of synthesizing speech having a degree of naturalness indicating a degree of similarity to speech uttered by a human higher than a predetermined reference value, when the speech element is used for synthesizing speech having reference prosody which is prosody serving as a reference, is stored in a storage device,
accepting requested prosody information representing requested prosody which is prosody requested by a user;
generating intermediate prosody information representing intermediate prosody which is prosody between the reference prosody and the requested prosody; and
executing a speech synthesis process to synthesize speech based on the generated intermediate prosody information and the stored speech element information.

9. The speech synthesis method according to claim 8, comprising:
selecting, for each of prosody candidates including the intermediate prosody, speech element information corresponding to the prosody candidate from the stored speech element information;
calculating, for each of the prosody candidates, a cost value varying according to the degree of naturalness of speech synthesized to have the prosody candidate, based on the selected speech element information; and
specifying one of the prosody candidates based on the calculated cost values, and executing the speech synthesis process to synthesize speech having the specified prosody candidate based on the speech element information selected for the specified prosody candidate.

10. The speech synthesis method according to claim 9, wherein:
the cost value is a value increasing as the degree to which the degree of naturalness is lower than the reference value becomes higher; and
the speech synthesis method is designed to specify a prosody candidate having the highest degree of similarity to the requested prosody among the prosody candidates the calculated cost values of which are smaller than a predetermined threshold.

11. A computer-readable medium storing a speech synthesis program comprising instructions for causing an information processing device to realize: speech element information storing process unit for storing in a storage device speech element information representing a speech element capable of synthesizing speech having a degree of naturalness indicating a degree of similarity to speech uttered by a human higher than a predetermined reference value when the speech element is used for synthesizing speech having reference prosody which is prosody serving as a reference;
requested prosody information accepting unit for accepting requested prosody information representing requested prosody which is prosody requested by a user;
intermediate prosody information generating unit for generating intermediate prosody information representing intermediate prosody which is prosody between the reference prosody and the requested prosody; and
speech synthesizing unit for executing a speech synthesis process to synthesize speech based on the generated intermediate prosody information and the stored speech element information.

12. The computer-readable medium according to claim 11, wherein:
the speech synthesizing unit comprises:
speech element information selection unit for selecting, for each of the prosody candidates including the intermediate prosody, speech element information corresponding to the prosody candidate from the stored speech element information; and
cost calculation unit for calculating, for each of the prosody candidates, a cost value varying according to the degree of naturalness of speech synthesized to have the prosody candidate, based on the selected speech element information; and
the speech synthesizing unit is configured to specify one of the prosody candidates based on the calculated cost values, and execute the speech synthesis process to synthesize speech having that prosody candidate, based on the speech element information selected for the specified prosody candidate.

13. The computer-readable medium according to claim 12, wherein:
the cost value is a value that increases as the degree to which the degree of naturalness is lower than the reference value becomes higher; and
the speech synthesizing unit is configured to specify a prosody candidate having the highest degree of similarity to the requested prosody among the prosody candidates the calculated cost values of which are smaller than the predetermined threshold.

14. A speech synthesis system comprising:
speech element information storage means for storing speech element information representing a speech element capable of synthesizing speech having a degree of naturalness indicating a degree of similarity to speech uttered by a human higher than a predetermined reference value when the speech element is used for synthesizing speech having reference prosody which is prosody serving as a reference;
requested prosody information accepting means for accepting requested prosody information representing requested prosody which is prosody requested by a user;
intermediate prosody information generating means for generating intermediate prosody information representing intermediate prosody which is prosody between the reference prosody and the requested prosody; and
speech synthesizing means for executing a speech synthesis process to synthesize speech based on the generated intermediate prosody information and the stored speech element information.
